(19) United States
(12) Patent Application Publication
(10) Pub. No.: US 2003/0033755 A1
(43) Pub. Date: Feb. 20, 2003

(54) Lightning protection

(76) Inventor: Henry J. Lord, Westwood, MA (US)

Correspondence Address: FISH & RICHARDSON PC, 225 FRANKLIN ST, BOSTON, MA, 02110, US

(21) Appl. No.: 09/929,753

(22) Filed: Aug. 14, 2001

(51) Int. Cl. H02G 13/00; E04B 1/34; B62D 63/04; E04B 1/98; E04H 9/02

(52) U.S. Cl. 52/3; 174/2

(57) ABSTRACT

A lightning shelter that is useful to provide temporary shelter on golf courses and for people engaged in other outdoor activities. The shelter includes a floor secured to the ground, walls extending upward from the floor and a roof that are connected together to define a completely enclosed, lightning protected region therein. The floor, walls and roof include metal electrically conductive material at least 0.03″ thick and having a maximum spacing between portions of conductive material of 4″. The metal electrically conductive material of the floor, walls and roof are electrically connected in a unitary electrical system so as to provide a Faraday cage enclosure that protects against lightning, shielding occupants within the shelter from very high voltage surges and protecting against internal arcs.

### BACKGROUND OF THE INVENTION

The invention relates to lightning shelters used to provide temporary shelter on golf courses and for people engaged in other outdoor activities.

Every year there are a number of fatalities on golf courses due to lightning strikes, since golf is played in open spaces and under weather conditions such that thunderstorms are frequently encountered. Currently, early warning systems are in place on many courses, and club policies advise players to seek shelter in the event of a warning signal.

The shelters on golf courses often merely provide shelter from rain. Where lightning protection is provided, it typically is based on the Ben Franklin system, including a lightning rod, down conductor and grounding device. E.g., Smith U.S. Pat. No. 6,167,896 describes a lightning shelter for golf courses that has an upward directed spike electrically connected to grounding spikes by spaced vertical metal poles. The shelter also has a wire mesh floor and a canvas cover to provide protection from the rain.

### SUMMARY OF THE INVENTION

The invention features, in general, a lightning shelter that is useful to provide temporary shelter on golf courses and for people engaged in other outdoor activities. The shelter includes a floor secured to the ground, walls extending upward from the floor and a roof that are connected together to define a completely enclosed, lightning protected region therein. The floor, walls and roof include metal electrically conductive material at least 0.03″ thick and having a maximum spacing between portions of conductive material of 4″. The metal electrically conductive material of the floor, walls and roof are electrically connected in a unitary electrical system so as to provide a Faraday cage enclosure that protects against lightning, shielding occupants within the shelter from very high voltage surges and protecting against internal arcs.

Particular embodiments of the invention may include one or more of the following features. At least some portions of the floor, walls or roof can include sheet metal that is at least 0.03″ thick. At least some portions of the floor, walls and/or roof can also include wire mesh made of wire that is at least 0.03″ thick and spaced from adjacent wires by 4″ or less. The walls can include one or more windows, each including wire mesh made of wire that is at least 0.03″ thick and spaced from adjacent wires by 4″ or less. Dielectric material can be placed inside of and closely adjacent to at least some portions of the floor, walls and/or roof. The dielectric material can be made of sheet rock material, rubber matting, vinyl or other plastic sheeting or other common building material with suitable insulating properties. The walls preferably are at least 8 feet high and the floor is at least 8 feet wide and 8 feet long. At least one wall includes a door including metal electrically conductive material. The protected region in the shelter is large enough to receive a golf cart, and the door is large enough to permit entry of said golf cart. The metal electrically conductive material is greater than 0.03″ thick. Preferably the walls are less than 20 feet high, and most preferably they are about 12 feet high, though in some embodiments they can be less than 12 feet high. Preferably the floors are about 12 feet by 35 feet or less.

Embodiments of the invention may include one or more of the following advantages. The invention provides a practical method for constructing shelters or enclosures, which diminish the risk of harm to people from lightning strikes. The shelter provides a Faraday cage that shields occupants and electrical equipment within the shelter from very high voltage surges and protects against internal arcs, by providing a surrounding, metal structure, in which all of parts are bonded together and carry the same electrical potential and in which metal penetrations are also electrically bonded to the structure. One can incorporate the required electrically conductive metal material to provide a Faraday cage without causing undue expense and using common construction techniques.

Other advantages and features of the invention will be apparent from the following discussion of particular embodiments thereof and from the claims.

### BRIEF DESCRIPTION OF THE DRAWINGS

FIG. 1 is a diagrammatic perspective view of a lightning shelter.

FIG. 2 is a diagrammatic perspective view of an alternative embodiment of a lightning shelter.

### DESCRIPTION OF THE PARTICULAR EMBODIMENTS

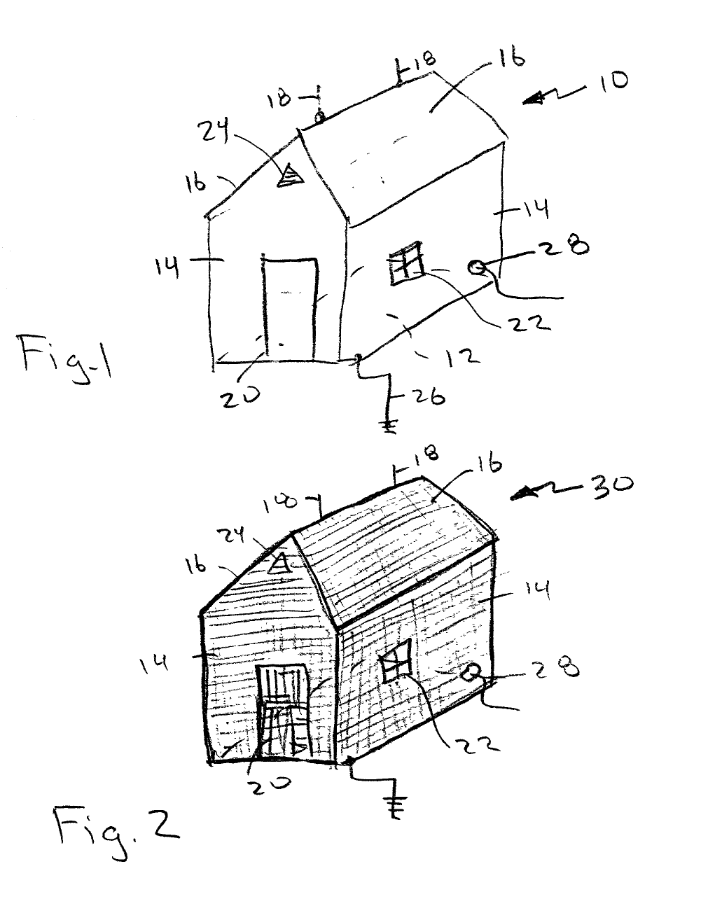

Referring to FIG. 1, lightning shelter 10 includes floor 12, walls 14, and roof 16 made of sheet metal that is greater than a minimum thickness, Tsm, supported on a structural framework (not shown). Floor 12 is secured to the ground by a simple foundation or other technique typical for structures of this size. Air terminals 18 extend upward from roof 16 and are electrically connected to it. Door 20, like the wall 14 in which it is installed, is made of sheet metal with thickness greater than Tsm supported on frame members to provide structural support. Window 22 includes metal wire mesh made of wire that is equal to or greater than a minimum cross-sectional dimension, Tw, and spaced from adjacent wires by no more than a maximum spacing, S. The metal mesh can be encased in glass of the window, or can be connected at its edges to the remainder of the wall 14 in which it is located. The sheet metal of door 20 and the wires of the wire mesh in window 22 are electrically connected to the sheet metal of the respective walls in which they are located. One or more walls 14 can include a vent 24, which includes wire mesh meeting the same requirements for the wire mesh in window 22. Grounding 26, e.g., metal grounding members, are electrically connected to the sheet metal in one or more walls 14. A utility conduit 28 is made of metal that is electrically connected to a wall 14 and provides access for a utility cable. Each portion of the electrically conductive metal material of floor 12, walls 14 and roof 16 is joined to other portions such that a continuous conductive surface is formed. The wire mesh can be made from round or flat stock. Shelter 10 should be at least 8 feet high and the floor should be at least 8 feet wide and 8 feet long. The shelters should preferably be about 12 feet high, though they could be as high as 20 feet. The floor could also be extended up to 12 feet by 35 feet, or potentially more, particularly if the shelter is designed to permit golf carts to be driven in.

FIG. 2 shows lightning shelter 30, which is similar to shelter 10, except the floor, walls and roof include wire mesh instead of sheet metal. The wire mesh is made of wire that as a cross-sectional dimension greater than or equal to Tw and spaced from adjacent wires by S or less. Preferably the roof 16 and potentially some or all of the walls 14 are covered with a waterproof material. As with the FIG. 1 shelter, structural members (not shown) are also employed to support the wire mesh and provide structure to the enclosure. Alternatively, the floor 12 and roof 16 could be made of sheet metal while the walls 14 still include the wire mesh. Other combinations of sheet metal and wire mesh are possible. As with the FIG. 1 enclosure, each portion of the electrically conductive metal material of floor 12, walls 14 and roof 16 is electrically connected to other portions such that a continuous conductive surface is formed. E.g., the wire mesh used in shelters 10, 30 can be tack welded at joints to provide continuous electrical connection.

Dielectric material can also be provided inside of the shelters along the floor, walls and roof to provide a standoff distance from the conductive material. The dielectric material can be sheet rock, rubber matting, vinyl or other plastic sheeting or other common building material with suitable insulating properties.

Tsm, Tw and S can be determined from theoretical analysis and the known electro-magnetic properties of lightning attachments, as described in Morris, et al., “Rocket-Triggered Lightning Studies for the Protection of Critical Assets,” IEEE Transactions on Industry Applications, Vol. 30, No. 3, May/June 1994 and in Morris, et al., “Lightning Protection Using Rudimentary Faraday Cages,” BOLT Technical Report #1, Rev. Apr. 29, 2001, BOLT, Inc., Albuquerque, N. Mex., which are hereby incorporated by reference.

The density of the mesh (and the diameter or thickness of the metal material) can be calculated as a function of the overall building dimensions consistent with the mathematical relationships as described in these references and with the known electro-magnetic properties of lightning attachments. In order to provide lightning protection for shelters for golf courses and the like (having the range of sizes described above), Tsm of 0.03″, a Tw of 0.03″, and S of 4″ should be employed. These values permit one to incorporate the required electrically conductive metal material without causing undue expense and using common construction techniques. Preferably the thickness of the sheet metal and cross-sectional dimension of the wire is kept below a maximum value of ¼″ to keep costs to an unprohibitive amount. Within these limits, the dimensions can be adjusted as desired according to the theoretical considerations set forth in the incorporated publications to provide a desired level of protection at a practical cost. Most preferably the spacing is 3″ or less and the thickness of the sheet metal and cross-sectional dimension of the wire is kept below 0.1″.

Shelters 10 and 30 provide a Faraday cage that shields occupants and electrical equipment within the shelters from very high voltage surges and protects against internal arcs. The principle is to provide a surrounding, metal structure, in which all of parts are bonded together and carry the same electrical potential and in which no penetrations exist in the structure. Even where there are openings, i.e., doors, windows, they include the electrically conductive metal material to maintain the continuous metal protection to reduce compromising the theoretical protection of the Faraday cage. Research has shown that by constructing even an “imperfect” Faraday cage as described herein, voltages inside the structure are reduced such that occupants are protected from injury.

Further protection is achieved by incorporating dielectric material on the inside surfaces of the structure, eliminating potential arcing effects. For example, in the BOLT Technical Report #1, the authors contrast the protection of well-bonded structures with poorly bonded buildings. The well-bonded building in their analysis is representative of a structure, which approaches the protection of a Faraday cage. The internal voltages as calculated for the well bonded building (i.e. the Faraday cage), fall in the range of 1.5 to 4.2 kilovolts. These maximum voltages then can produce internal arcs, which can damage building contents. Using an accepted value for the insulating properties of air and a safety factor, a standoff distance of 1 cm is calculated for an extreme lightning attachment. At these voltages, a suitable dielectric material for the inside surfaces can be easily provided using common building materials and without unreasonable cost.

This example was calculated for a metal mesh density less tight than what is suggested herein and therefore the structures built under this claim are expected to provide a greater protection against internal arcs. In the case where metal conduits or other penetrations are used to deliver utilities to the inside of the structure, each such penetration is electrically bonded to the outer surface of the Faraday cage, extending protection to the contents of the conduit.

Other embodiments of the invention are within the scope of the appended claims. E.g., outer dimensions, the length and number of walls, the number, size and location of doors, windows and ventilation structures, and the roof configurations of such a structure are variable depending upon the intended use. It is also intended in this embodiment that such shelters will incorporate standard building methods to construct and in addition to lightning protection, provide rain protection to occupants inside the structure.

What is claimed is:

1. A lightning shelter useful to provide temporary shelter on golf courses and for people engaged in other outdoor activities, said shelter comprising
a floor secured to the ground,
walls extending upward from said floor and having upper portions,
a roof overlying said floor and connected to said upper portions of said walls to define an enclosed, lightning protected region therein, said roof providing protection from rain,
said floor, walls and roof including metal electrically conductive material at least 0.03″ thick and having a maximum spacing between portions of conductive material of 4″, said metal electrically conductive material of said floor, walls and roof being electrically connected in a unitary electrical system so as to provide a Faraday cage enclosure.

2. The shelter of claim 1 wherein at least some portions of said floor, walls or roof include sheet metal that is at least 0.03″ thick.

3. The shelter of claim 1 wherein at least some portions of said floor, walls and/or roof include wire mesh made of wire that is at least 0.03″ thick and spaced from adjacent wires by 4″ or less.

4. The shelter of claim 1 wherein said walls include one or more windows, each said window including wire mesh made of wire that is at least 0.03″ thick and spaced from adjacent wires by 4″ or less.

5. The shelter of claim 1, further comprising dielectric material inside of and closely adjacent to at least some portions of said floor, walls and/or roof.

6. The shelter of claim 5 wherein said dielectric material comprises sheet rock material.

7. The shelter of claim 5 wherein said dielectric material comprises one or more materials from the group consisting of rubber matting, vinyl or other plastic sheeting and other common building material with suitable insulating properties.

8. The shelter of claim 1 wherein said walls are at least 8 feet high and said floor is at least 8 feet wide and 8 feet long.

9. The shelter of claim 1 wherein at least one wall includes a door having said metal electrically conductive material.

10. The shelter of claim 9 wherein said region is large enough to receive a golf cart and said door is large enough to permit entry of said golf cart.

11. The shelter of claim 1 wherein said metal electrically conductive material is greater than 0.03″ thick.

12. The shelter of claim 8 wherein said walls are less than 20 feet high.

13. The shelter of claim 8 wherein said walls are about 12 feet high.

14. The shelter of claim 8 wherein said walls are less than 12 feet high.

15. The shelter of claim 8 wherein said floors is about 12 feet by 35 feet or less.
